(19) United States
(12) Patent Application Publication
(10) Pub. No.: US 2011/0274301 A1
(43) Pub. Date: Nov. 10, 2011

(54) Underwater Transducer Apparatus Using Polarized Stacked Piezoelectric Elements and a Method of Operating the Same

(75) Inventor: Jerry Peck, Mission Viejo, CA (US)

(73) Assignee: UNDERSEA SYSTEMS INTERNATIONAL, INC., Santa Ana, CA (US)

(21) Appl. No.: 12/774,478

(22) Filed: May 5, 2010

(51) Int. Cl. H04R 25/00

(52) U.S. Cl. 381/190

(57) ABSTRACT

The current device is a transducer for underwater communication using a plurality of stacked polarized piezoelectric elements. The piezoelectric elements are stacked within a communication device such as a loudspeaker or a set of headphones or earphones so that the polarity of each element is orientated in the same direction. When the elements are activated, the elements operate in phase and drive a pressure or sound wave to its intended recipient at a significantly high volume. The transducer may also be configured to receive acoustic signals within a device such as a microphone by collecting the acoustic signals in phase by the stacked piezoelectric elements from a user. The elements convert the acoustic signals to electrical signals which are then transmitted to another user.

### BACKGROUND OF THE INVENTION

1. Field of the Invention

The invention relates to the field of underwater transducers, namely an apparatus and method that receives electric signals and transmits enhanced acoustic signals from diver-to-diver or from surface-to-diver through water.

2. Description of the Prior Art

Transducers have long been used in underwater communication systems and devices to receive acoustic signals from one diver to another or from a surface vessel to a diver. Typically a diver will have a transducer or a plurality of transducers mounted in the ear section of their diving masks. In many instances, the transducer takes the form of a headphone or earphone which is placed directly into the diver's ear. When the diver receives an electric audio signal, the signal is sent to the transducer and then converted into a pressure or sound wave by a type of magnet and piston or solenoid configuration which is then heard by the diver wearing the earphones. Additionally, underwater speakers suspended from a surface vessel operate on the same principle, except when the audio signal is converted into a pressure wave, the wave must then be sent through several meters of water at varying temperatures and depths to its intended recipient.

Additionally, transducers have also been used underwater to transmit acoustic signals from one diver to another diver or from a diver to a surface vessel. The diver speaks into a transducer located in or around the mouth piece of their diving mask and the sound waves of his or her voice are then converted into electrical signals by the transducer. The electrical signals are then transmitted on to its intended recipient, be it another diver or a surface vessel and received in the same manner as described above, although obtaining high bandwidth and long distance electromagnetic communication in sea water or even fresh water is all but impossible with conventional technologies and even short range communication is subject to high attenuation.

While the use of transducers in underwater acoustic communication systems has had varying levels of success, several limitations have hindered these devices from reaching their full potential.

Many systems and devices that use traditional magnet and piston or solenoid configurations lack the power to send or receive acoustic signals through relatively large distances of water thus limiting the range in which divers may dive from a vessel or from each other. Even if a system or device has the power needed to communicate with other units over large distances, what is transmitted or received is of such poor quality that little if any of the acoustic message being sent is understood, thus rendering any communication extremely difficult or pointless.

Additionally, in order for many transducers to achieve the kind of power needed to communicate over long distances, several additional pieces of equipment such as amplifiers and the like are required. This makes any device with sufficient long range communication power heavy and cumbersome which is extremely undesirable when diving underwater.

Finally, the magnet and piston or solenoid configurations used in the prior art have a certain depth limitation. As the outside water pressure increases as the diver descends, the ability of the magnet to push the piston back in the direction of the water pressure decreases dramatically, making communication below certain depths impossible. In some cases the water pressure may be too great for the device causing the housing of the device to buckle inward preventing all solenoid movement completely.

What is needed is a device and method that effectively transmits and receives acoustic signals through large distances of water with clarity and accuracy in a variety of depths while still maintaining a lightweight and compact profile.

### BRIEF SUMMARY OF THE INVENTION

The current invention is a transducer for underwater communications comprising a housing, a rod coupled to the housing, a first polarized piezoelectric element having a corresponding direction of polarization, and a second polarized piezoelectric element having a corresponding direction of polarization, wherein the first and second piezoelectric elements are coupled to the rod and oriented with respect to each other so that the directions of polarization of the first and second piezoelectric elements are the same. The rod of the transducer has a head and further comprises at least one washer disposed on the rod, the washer being disposed between the first piezoelectric element and the head of the rod. Additionally, the transducer further comprises at least one washer disposed onto the rod, the washer being disposed between the first and second piezoelectric elements. Finally, the transducer further comprises a wire with a positive lead and a negative lead within the housing which is electrically coupled to the first piezoelectric element.

In one embodiment, the positive lead within the transducer is electrically coupled to only one surface of the first piezoelectric element and similarly, the negative lead is electrically coupled to only the opposing surface of the first piezoelectric element. The transducer of this embodiment further comprises a positive jumper lead electrically coupling the surface of the first piezoelectric element with the positive lead to the same corresponding surface of the second piezoelectric element, and a negative jumper lead electrically coupling the surface of the first piezoelectric element with the negative lead to the same corresponding opposing surface of the second piezoelectric element.

In another embodiment, the transducer further comprises means for driving the first and second piezoelectric elements to operate in phase with each other.

It is an object of the invention to provide a transducer that may be used in a diving mask and comprise means for adapting to use as either a earphone or microphone unit in the diving mask.

The current invention also provides for a transducer for underwater communications comprising a waterproof shell substantially spherical in shape defining an inner cavity, a central anchor disposed within the inner cavity of the shell, and at least two polarized piezoelectric stacks coupled to the central anchor and disposed within the shell. The at least two piezoelectric stacks within the transducer each comprise a plurality of polarized piezoelectric elements, a plurality of washers disposed between each of the polarized piezoelectric elements, and at least one washer disposed between the central anchor and the first polarized piezoelectric element of the piezoelectric stack and at least one washer disposed between the last polarized piezoelectric element of the piezoelectric stack and the shell. Additionally, the transducer further comprises a plurality of wires, each with a positive lead and a negative lead within the shell and coupled to the first polarized piezoelectric element of each polarized piezoelectric stack closest to the central anchor. The positive lead of each wire is coupled to only one surface of the first polarized piezoelectric element of each polarized piezoelectric stack and where the negative lead is coupled to only the opposing surface of the first polarized piezoelectric element of each polarized piezoelectric stack. Finally, the transducer also comprises a plurality of positive jumper leads coupling the surface of the first polarized piezoelectric element with the positive lead to the same corresponding surfaces of each of the next more radially distant polarized piezoelectric elements within the polarized piezoelectric stack, and a plurality of negative jumper leads coupling the surface of the first polarized piezoelectric element with the negative lead to the same corresponding opposing surfaces of each of the next more radially distant polarized piezoelectric elements within the polarized piezoelectric stack.

In another embodiment, the transducer further comprises means for operating the plurality of polarized piezoelectric elements within each polarized piezoelectric stack in constructive interference.

In yet another embodiment, the transducer further comprises means for operating each polarized piezoelectric stack in constructive interference with each other polarized piezoelectric stack.

The current invention also provides for a method for communicating underwater comprising providing an underwater transducer including a plurality of polarized piezoelectric elements within a waterproof housing with a plurality of polarized piezoelectric elements separated from each other and from the housing, applying a positive voltage to only one surface of each of the polarized piezoelectric elements and a negative voltage to only the opposing surface of each of the polarized piezoelectric elements, and operating the plurality of polarized piezoelectric elements in phase with each other to produce constructive interference. The method further comprises disposing a plurality of polarized stacks of polarized piezoelectric elements within the housing and operating the plurality of polarized stacks in phase with each other to produce constructive interference.

It is an object of the invention to use the method described above when operating the underwater transducer within an ear or mouth piece of a diving mask.

In another embodiment, the method further comprises suspending the underwater transducer from a surface vessel or other flotation means and operating the underwater transducer in free water,

Finally, in another embodiment, the method further comprises operating the underwater transducer in a mode as a speaker or as a microphone, or selectively in either mode without modification of the underwater transducer depending on the mode of operation.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a side cross sectional side view of a earphone embodiment of the stacked element transducer of the illustrated embodiment of the invention as seen through section lines A-A of FIG. 3.

FIG. 2 is a top plan view of the embodiment of the stacked element transducer shown in FIG. 1.

FIG. 3 is an side plan view of the embodiment of the stacked element transducer shown in FIG. 1.

FIG. 4 is a side cross sectional side view of another embodiment of the underwater speaker of the stacked element transducer.

FIG. 5 is a magnified view of a portion of the stacked element transducer shown in FIG. 1.

FIG. 6 is a magnified view of the embodiment of the stacked element transducer shown in FIG. 4.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The illustrated embodiment is a transducer for underwater communication using a plurality of stacked polarized piezoelectric elements. The plurality of piezoelectric elements are stacked within a communication device such as a loudspeaker or a earphone so that the polarity of each element of the plurality is orientated in the same direction. When the elements are activated, the elements operate in phase and drive a pressure or sound wave in the intended direction at a significantly high volume. The transducer may also be configured to receive acoustic signals within a device such as a microphone by collecting the acoustic signals and transducing an electrical output in phase by the stacked piezoelectric elements. The elements convert the acoustic signals to electrical signals which are then transmitted to another user by electrical means known in the art.

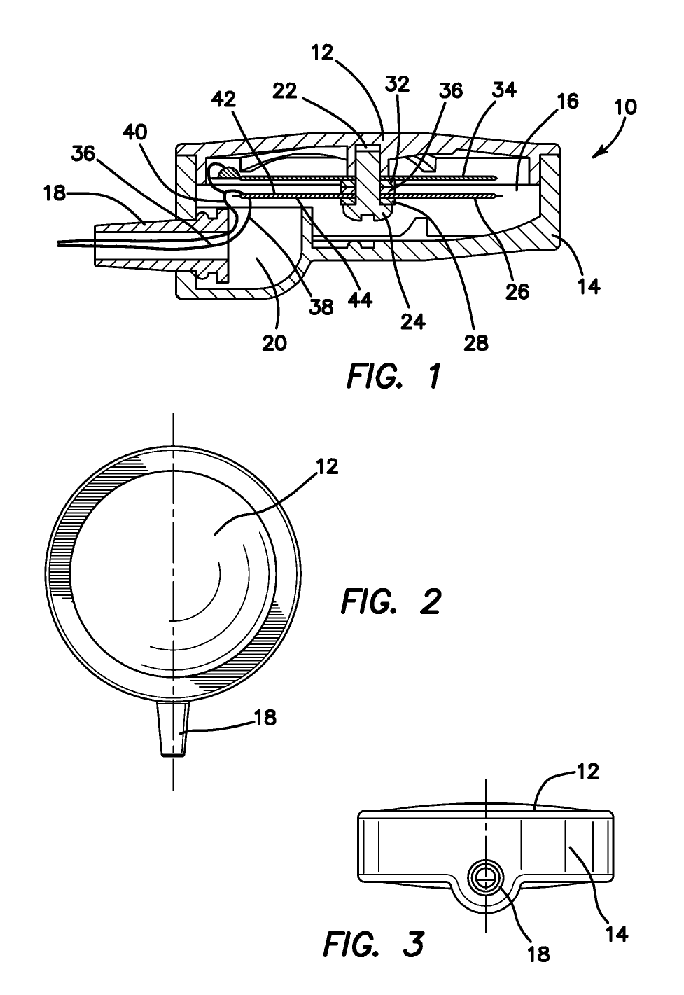

A first illustrated embodiment of the invention may be seen in a diver's earphone embodiment in FIG. 1 where the earphone has been given general reference numeral 10. The earphone 10 is comprised of two main outside components, a base or housing 14 and a cap 12. The earphone 10 is preferably a circular shape as seen in FIG. 2, however this is meant for illustrative purposes only as other geometric shapes could be easily used. The cap 12 is disposed on top of the housing 14 as seen in FIG. 3 and is coupled to the housing 14 so as to provide a water tight seal all around the circumference of the earphone 10. Both the housing 14 and cap 12 are preferably comprised of lightweight durable plastic or plastic composites, however other materials resistant to water, such as rubber may be used without departing from the original spirit and scope of the invention.

With the cap 12 coupled to the housing 14, a hollow, air filled, inner cavity 16 is defined or formed. Defined within a portion of the cavity 16 is a well 20. The well 20 is a shaped portion of the housing 14 that is filled in with a solid water proof resin that extends into the housing 14 as seen in FIG. 1. The distal portion of a penetrator 18 is disposed within the well 20 with the proximal portion of the penetrator 18 extending beyond the circular wall of the housing 14. The penetrator 18 is only coupled within the well 20 of the earphone 10 and does not extend into or breach the inner cavity 16. This is so that electrical wires or other water sensitive elements may be safely kept from water or excess moisture by passing through the penetrator 18 then directly into the well 20, which is substantially filled with water proof resin and then into the inner cavity 16.

Defined within the underside of the cap 12 is a tap 22 sized and shaped to accommodate a screw 24. Before the screw 24 is coupled to the tap 22, a plurality of disc shaped polarized piezoelectric elements 26, 34 and a plurality of washers 28, 30, 32 are disposed or threaded onto the screw. In the illustrated embodiment polarized piezoelectric elements 26, 34 are disc-shaped polarized or oriented piezoceramic single or multiple layered elements as is conventionally manufactured, but it is within the scope of the invention that any shaped or type of polarized piezoelectric element may be equivalently employed. Preferably, as shown in FIG. 1, the first element to be disposed on screw 24 is a first washer 28 followed by a first piezoelectric element 26. Next disposed onto the screw 24 are a second and third washer 30 and 32 followed finally by a second polarized piezoelectric element 34. Piezoelectric elements 26 and 34 are oriented in the same direction with respect to their polarization, e.g. if the top of piezoelectric element 26 as seen in the illustration of FIG. 1 is the positive electrode, then the top of piezoelectric element 34 as seen in the illustration of FIG. 1 is the positive electrode as well and similarly if the negative electrode is oriented on top. The second washer 30 and the third washer 32 serve to defined a buffer zone or spacing of predetermined size so that when the piezoelectric elements 26, 34 are activated, they do not vibrate into one another and cause interference and are optimized for in-phase resonance or constructive interference with each other.

It is this alternating sequence of piezoelectric element and washer or plurality of washers that comprise a “stack” or “piezoelectric stack.” It is important to note that the exact number of washers 28, 30, 32 and piezoelectric elements 26, 34 and the order and spacing in which they are configured within the stack may be varied without departing from the original spirit and scope of the invention. For example, any number of additional piezoelectric elements may be threaded onto the screw 24 as long as additional corresponding washers are also threaded onto the screw 24 so as to keep the piezoelectric elements from vibrating into or touching each other and to optimize their constructive interference or resonance with each other.

Once all the components of the stack have been threaded onto the screw 24, the screw 24 is then coupled to the cap 12 through the means of the tap 22. The screw 24 is sufficiently long enough so as to provide adequate coupling to the cap 12 as well as for maintaining the piezoelectric stack in a suspended position within the inner cavity 16 so as to prevent any contact between the stack and the housing 14 or well 20.

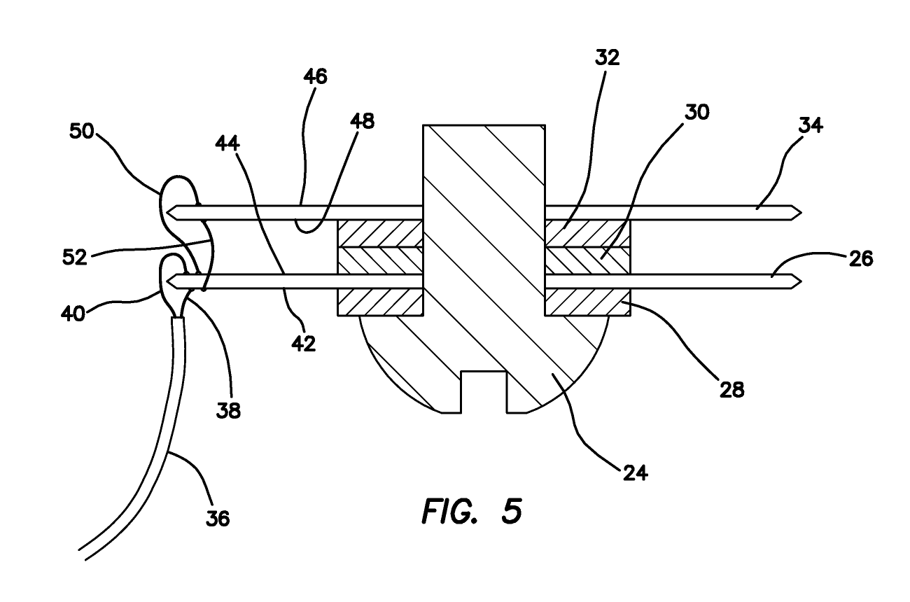

A wire or a plurality of electrical wires 36 extending from a transmitter/receiver unit located on the diver's belt, mask or other location (not shown) travel up to where the earphone 10 is located within the diver's mask, preferably in or around the ear region of the diver. The wire 36, which carries a positive lead 40 and a negative lead 38 as seen in FIG. 5, enter the earphone 10 through the penetrator 18 and the well 20 filled with water proof resin. In a preferred embodiment of the invention the wire 36 delivers an alternating current to the positive lead 40 and the negative lead 38; however a direct current may also be delivered to the leads 38, 40 without departing from the original spirit and scope of the invention.

In the illustrated embodiment as illustrated in FIG. 5 the wire 36 lead through the inner cavity 16, it is coupled to the first piezoelectric element 26 with the positive lead 40 coupled to the top surface or electrode 44 of the piezoelectric element 26 by means known in the art. Similarly, the negative lead 38 is coupled to the bottom surface or electrode 42 of the piezoelectric element 26 by means known in the art. A positive jumper lead 50 and a negative jumper lead 52 are also coupled to the top surface 44 and bottom surface 42 respectively of the piezoelectric element 26. The opposite end of the positive jumper lead 50 is coupled to the top surface or electrode 46 of the second piezoelectric element 34. Similarly, the opposite end of the negative jumper lead 52 is coupled to the bottom surface or electrode 48 of the second piezoelectric element 34 so that piezoelectric elements 26 and 34 are electrically coupled in parallel. It is in this fashion that a positive voltage is established on the top surfaces 44, 46 of the first and second piezoelectric elements 26, 34 and a negative voltage is established on the bottom surfaces 42, 48 of the first and second piezoelectric elements 26, 34. Having both top surfaces 44, 46 with one voltage orientation and both of the bottom surfaces 42, 48 with the opposing voltage orientation allows both piezoelectric elements 26, 34 to vibrate in phase when activated. In other words, when an electrical signal is sent through the wire 36 and into the respective surfaces of the piezoelectric elements 26, 34, the piezoelectric elements 26, 34 operate in constructive interference thus significantly increasing the volume of the acoustic signal that they create. The created acoustic signal then propagates through the cap 16 of the earphone 10 and into the ear of the user. However, if desired piezoelectric elements 26, 34 could also be coupled electrically in series. There symmetrically oriented polarization insures that the driving electrical voltage drives the elements in a constructive manner.

It is to be expressly understood that while the above disclosure specifies that a positive voltage is established on the top surfaces 44, 46 of the piezoelectric elements 26, 34 and a negative voltage is established on the bottom surfaces 42, 48 of those same piezoelectric elements 26, 34, the specific voltages established may be changed or swapped at will without departing from the original spirit and scope of the invention. That it is to say, the top surfaces 44, 46 may instead have a negative voltage and the bottom surfaces 42, 48 may have a positive voltage from the leads 38, 40. As long as each piezoelectric element 26, 34 within the earphone 10 is configured to operate in phase with every other piezoelectric element, any voltage orientation on the surfaces of the piezoelectric elements 26, 34 is well within the scope of the invention.

Other than the vibrating piezoelectric elements 26, 34, no moving parts are contained within the earphone 10. This allows the earphone 10 to be taken to depths down below previous depths permitted by the prior art as there is no diaphragm or piston that can ill effected by the increasing outside water pressure.

In an alternative embodiment, the transducer device may be used as a microphone. In this particular embodiment, the earphone 10 is placed within a microphone cavity of a diver's mask (not shown). When the diver speaks, the acoustic signals of the diver's voice carries through the cap 12 and into the piezoelectric elements 26, 34. The piezoelectric elements 26, 34 convert the acoustic signals to electrical signals as known in the art and send the electric signals through the wire 36 and out of the earphone 10 through the penetrator 18. From there, the electric signals are sent down to the diver's transmitter/receiver unit (not shown) and then transmitted to another diver or surface vessel by means currently known in the art or later devised.

In this embodiment, the piezoelectric stack is unchanged from the earphone embodiment described above. By simply adjusting or changing the connection configuration with the transmitter/receiver unit, the piezoelectric stack may be used as either a earphone or microphone with no structural modification to the piezoelectric stack itself.

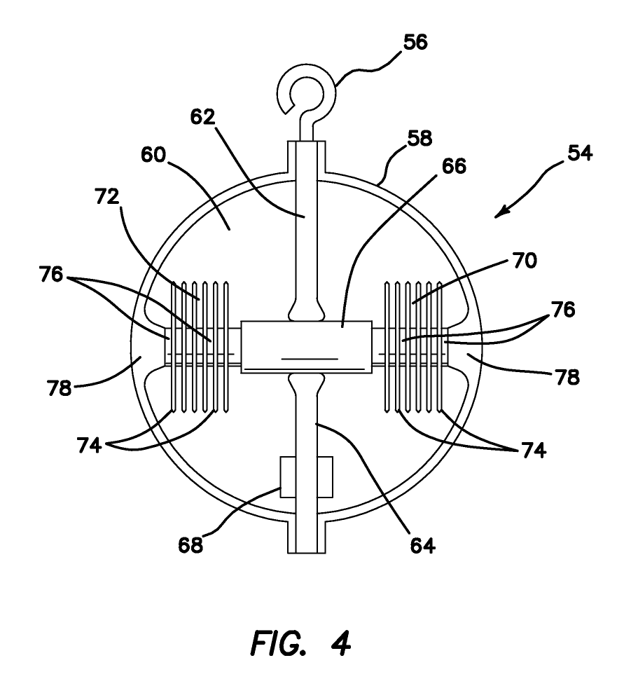

A further embodiment of the current transducer device is shown in FIG. 4 where a variation of the piezoelectric stack is disposed within an underwater speaker, generally denoted by reference numeral 54. The speaker 54 comprises a shell 58 that is substantially spherical in shape so as to best resist the outside water pressure that increases around the speaker 54 as it travels into deeper water depths. The speaker 54 also comprises an eye bolt 56 disposed at the top of the shell 58. The eye bolt 56 allows a surface vessel by means of a hook, cable, or other similar means (not shown) to couple to the speaker 54. The surface vessel may then troll, raise or lower the speaker 54 by the means of the hook or cable to a desired depth and location.

Defined within the shell 58 of the speaker 54 is an inner cavity 60. Disposed through the y-axis of the inner cavity 60 is an eye bolt stem 62 and a weight stem 64. Coupled between the eye bolt stem 62 and the weight stem 64 is a central anchor 66. The top portion of the eye bolt stem 62 is coupled to the eye bolt 62 while the bottom portion is coupled to the central anchor 66. Similarly, the weight stem 64 is coupled to the central anchor 66 at its top portion and to the bottom of the shell 58 at its bottom portion. Also coupled to the weight stem 64 is a weight 68. The weight 68 counteracts the buoyant force of the speaker 54 and maintains the speaker 54 with neutral buoyancy.

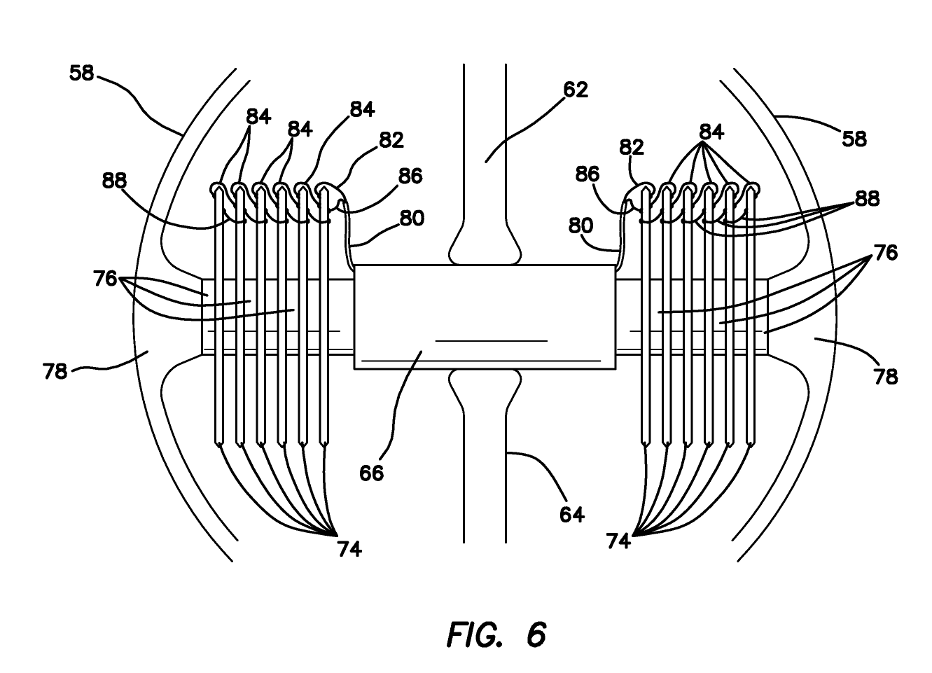

Defined through the x-axis or horizontal axis of the inner cavity 60 as seen in the illustration of FIGS. 4 and 6 is the piezoelectric stack. In this particular embodiment, there are two piezoelectric stacks, a right piezoelectric stack 70 and a left piezoelectric stack 72, each one extending radially from the central anchor 66 to the shell 58. Each piezoelectric stack 70, 72 comprises a threaded rod (not shown), a plurality of piezoelectric elements 74, and a plurality of washers 76. Preferably, the threaded rod is coupled to the central anchor 66 and extends substantially straight radially outward therefrom to the shell 58 where it is coupled to the shell 58 by means of a shell boss 78. Beginning at the central anchor 66, at least one of the plurality of washers 76 is disposed onto the rod followed by the first of the plurality of piezoelectric elements 74. Following the first of the plurality of piezoelectric elements 74, at least an additional one of the plurality of washers 76 follows it on the rod. This alternating sequence of washer 76 and piezoelectric element 74 thus forms the piezoelectric stack and may be repeated without limit for both piezoelectric stacks 70, 72. The washers 76 may in fact be conventional washers, however any spacing elements that separate the piezoelectric elements 76 from each other and from the central anchor 66 and shell 58 may be used. In FIG. 4, it is shown that each piezoelectric stack 70, 72 comprises six piezoelectric elements 74 and a corresponding amount of washers 76, however this is meant for illustrative purposes only. Fewer or additional piezoelectric elements 74 may be used within each piezoelectric stack 70, 72 that what is shown without departing from the original spirit and scope of the invention. Additionally, fewer or more piezoelectric stacks 70, 72 may be housed within the inner cavity 60 then what is shown in FIG. 4.

The central anchor 66 is not only a means of support for the rear portion of each piezoelectric stack 70, 72, but it also serves as a reflective load or tail mass. The use of a tail mass is well known in the art when designing a stacked piston or other similar transducer. The main purpose of the tail mass is to reflect acoustic energy toward the front of the shell 58 and minimize the negative effect of acoustic out of phase cancellation. The mass dimensions of the shell 58 are adjusted to optimize this process at a specific range of frequencies as is known in the art.

The detail of the electronic coupling of the piezoelectric stacks 70, 72 can be seen in FIG. 6. A plurality of wires 80 each comprising a positive lead 82 and a negative lead 86 extend from the central anchor 66. Wires 80 are coupled to a cable led through stem 62, which cable in turn is coupled through shell 58 by means of a conventional waterproof penetrator (not shown). The wires 80 are coupled to the first the plurality of piezoelectric elements 74 with the positive lead 82 coupled to the top surface of the piezoelectric element 74 by means known in the art. Similarly, the negative lead 86 is coupled to the bottom surface of the piezoelectric element 74 by means known in the art. A plurality of positive jumper leads 84 and a plurality of negative jumper lead 88 are also coupled to the top surface and bottom surface respectively of each of the piezoelectric elements 74. The opposite end of each positive jumper lead 84 is coupled to the top surface of the next radially disposed piezoelectric element 74. Similarly, the opposite end of the negative jumper lead 88 is coupled to the bottom surfaces of the next radially disposed piezoelectric element 74. This configuration of each positive jumper lead 84 and each negative jumper lead 88 being coupled to the same respective surface of each corresponding piezoelectric element 74 is repeated for as many piezoelectric elements 74 as there are within each piezoelectric stack 70, 72, coupling them in parallel. The polarity of stacks 70 and 72 within shell 58 are mutually oriented with respect to each other so that each stack operates in constructive interference with the other.

It is in this configuration that a positive voltage is established on the top surfaces of each of the piezoelectric elements 74 and a negative voltage is established on the bottom surfaces of each of the piezoelectric elements 74. Having all the top surfaces of the piezoelectric elements 74 with one polarity orientation and all of the bottom surfaces of the piezoelectric elements 74 with the opposing polarity orientation allows all of the piezoelectric elements 74 to vibrate in phase when activated. In other words, when an electrical signal is sent through the wires 80 and into the respective surfaces of the piezoelectric elements 74, the piezoelectric elements 74 operate in constructive interference thus significantly increasing the volume of the acoustic signal that they create. The created acoustic signal then propagates through the shell 58 of the speaker 54 and into the surrounding water.

It is to be expressly understood that while the above disclosure specifies that a positive voltage is established on the top surfaces of each of the piezoelectric elements 74 and a negative voltage is established on the bottom surfaces of each of those same piezoelectric elements 74, the specific voltages established may be changed or swapped at will without departing from the original spirit and scope of the invention. That it is to say, the top surfaces may instead have a negative voltage and the bottom surfaces may have a positive voltage from the wires 80. As long as each piezoelectric element 74 within each piezoelectric stack 70, 72 is configured to operate in phase with every other piezoelectric element 74, any voltage orientation on the surfaces of the piezoelectric elements 74 is well within the scope of the invention. It is contemplated as being within the scope of the invention that the oriented elements in each stack 70 and 72 may be electrically coupled in series with each other and the stacks then coupled in series or parallel with each other as desired.

Other than the vibrating piezoelectric elements 74, no moving parts are contained within the speaker 53. This allows the speaker 54 to be taken to depths down below previous depths permitted by the prior art as there is no diaphragm or piston that can be ill effected by the increasing outside water pressure.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A transducer for underwater communications comprising:
a housing;
a rod coupled to the housing;
a first polarized piezoelectric element having a corresponding direction of polarization; and
a second polarized piezoelectric element having a corresponding direction of polarization,
wherein the first and second piezoelectric elements are coupled to the rod and oriented with respect to each other so that the directions of polarization of the first and second piezoelectric elements are the same.

2. The transducer of claim 1 where the rod has a head and further comprising at least one washer disposed on the rod, the washer being disposed between the first piezoelectric element and the head of the rod.

3. The transducer of claim 1 further comprising at least one washer disposed onto the rod, the washer being disposed between the first and second piezoelectric elements.

4. The transducer of claim 1 further comprising a wire with a positive lead and a negative lead within the housing and electrically coupled to the first piezoelectric element.

5. The transducer of claim 4 where the positive lead is electrically coupled to only one surface of the first piezoelectric element and where the negative lead is electrically coupled to only the opposing surface of the first piezoelectric element.

6. The transducer of claim 5 further comprising:
a positive jumper lead electrically coupling the surface of the first piezoelectric element with the positive lead to the same corresponding surface of the second piezoelectric element; and
a negative jumper lead electrically coupling the surface of the first piezoelectric element with the negative lead to the same corresponding opposing surface of the second piezoelectric element.

7. The transducer of claim 1 further comprising means for driving the first and second piezoelectric elements to operate in phase with each other.

8. The transducer of claim 1 for use in a diving mask and further comprising means for adapting the transducer to use as either a earphone or microphone unit in the diving mask.

9. A transducer for underwater communications comprising:
a waterproof shell substantially spherical in shape defining an inner cavity;
a central anchor disposed within the inner cavity of the shell; and
at least two polarized piezoelectric stacks coupled to the central anchor and disposed within the shell.

10. The transducer of claim 9 where the at least two piezoelectric stacks each comprise:
a plurality of polarized piezoelectric elements;
a plurality of washers disposed between each of the polarized piezoelectric elements; and
at least one washer disposed between the central anchor and the first polarized piezoelectric element of the piezoelectric stack and at least one washer disposed between the last polarized piezoelectric element of the piezoelectric stack and the shell.

11. The transducer of claim 10 further comprising a plurality of wires, each with a positive lead and a negative lead within the shell and coupled to the first polarized piezoelectric element of each polarized piezoelectric stack closest to the central anchor.

12. The transducer of claim 11 where the positive lead of each wire is coupled to only one surface of the first polarized piezoelectric element of each polarized piezoelectric stack and where the negative lead is coupled to only the opposing surface of the first polarized piezoelectric element of each polarized piezoelectric stack.

13. The transducer of claim 12 further comprising:
a plurality of positive jumper leads coupling the surface of the first polarized piezoelectric element with the positive lead to the same corresponding surfaces of each of the next more radially distant polarized piezoelectric elements within the polarized piezoelectric stack; and
a plurality of negative jumper leads coupling the surface of the first polarized piezoelectric element with the negative lead to the same corresponding opposing surfaces of each of the next more radially distant polarized piezoelectric elements within the polarized piezoelectric stack.

14. The transducer of claim 10 further comprising means for operating the plurality of polarized piezoelectric elements within each polarized piezoelectric stack in constructive interference.

15. The transducer of claim 10 further comprising means for operating each polarized piezoelectric stack in constructive interference with each other polarized piezoelectric stack.

16. A method for communicating underwater comprising:
providing an underwater transducer including a plurality of polarized piezoelectric elements within a waterproof housing with a plurality of polarized piezoelectric elements separated from each other and from the housing;
applying a positive voltage to only one surface of each of the polarized piezoelectric elements and a negative voltage to only the opposing surface of each of the polarized piezoelectric elements; and
operating the plurality of polarized piezoelectric elements in phase with each other to produce constructive interference.

17. The method of claim 16 further comprising disposing a plurality of polarized stacks of polarized piezoelectric elements within the housing and operating the plurality of polarized stacks in phase with each other to produce constructive interference.

18. The method of claim 16 further comprising operating the underwater transducer within an ear or mouth piece of a diving mask.

19. The method of claim 16 further comprising suspending the underwater transducer from a surface vessel or other flotation means and operating the underwater transducer in free water.

20. The method of claim 16 further comprising operating the underwater transducer in a mode as a speaker or as a microphone, or selectively in either mode without modification of the underwater transducer depending on the mode of operation.
